(19) United States
(12) Patent Application Publication
(10) Pub. No.: US 2020/0213261 A1
(43) Pub. Date: Jul. 2, 2020

(54) SELECTING A MODALITY FOR PROVIDING A MESSAGE BASED ON A MODE OF OPERATION OF OUTPUT DEVICES

(71) Applicant: SIGNIFY HOLDING B.V., EINDHOVEN (NL)

(72) Inventors: BERENT WILLEM MEERBEEK, VELDHOVEN (NL); TIM DEKKER, EINDHOVEN (NL); JOCHEN RENAAT VAN GHELUWE, LOMMEL (BE); ANTHONIE HENDRIK BERGMAN, NUENEN (NL)

(21) Appl. No.: 16/632,481

(22) PCT Filed: Jul. 16, 2018
(86) PCT No.: PCT/EP2018/069246

§ 371 Date: Jan. 20, 2020

(30) Foreign Application Priority Data
Jul. 19, 2017 (EP) 17182022.8

(51) Int. Cl. H04L 12/58; H04W 4/12

(52) U.S. Cl. CPC H04L 51/24; H04L 51/02; H04W 4/12; H04L 51/26; H04L 51/14; H04L 51/04

(57) ABSTRACT

An electronic device (1) is configured to determine a message to be provided to a user and obtain a current mode of operation of a system capable of outputting audio (1) and a current mode of operation of a system capable of outputting light (43-45). The electronic device is further configured to select a modality for providing the message to the user from a plurality of modalities and a system for providing the message to the user from a plurality of systems based on the obtained current modes of operation. The modalities include at least light and audio. The plurality of systems comprises the system capable of outputting audio and the system capable of outputting light. The electronic device is also configured to cause the selected system to provide the message to the user in the selected modality.

### FIELD OF THE INVENTION

The invention relates to an electronic device for causing a system to provide a message.

The invention further relates to a method of causing a system to provide a message.

The invention also relates to a computer program product enabling a computer system to perform such a method.

### BACKGROUND OF THE INVENTION

There is an emergence of digital assistants in the home (e.g. Amazon Echo, Google Home, Siri). These digital assistants can present notifications to their users based on certain events. For example, Amazon Echo's most used function is setting timers and reminders. Amazon echo provides notifications by making a chiming noise and lighting up.

CN106453889A discloses a device, e.g. a mobile phone, which provides an intelligent reminder with one or more of light, audio, and vibration output and determines the light, audio, and vibration output levels used for providing the intelligent reminder based on the light and sound intensity of the ambient environment.

A drawback of these devices is that they are not able to take advantage of other output devices that may be present for providing notifications and as a result, their notifications are sometimes not pronounced enough to be noticed by a user and/or may disturb the user too much at other times and are therefore not provided in a sufficiently effective manner.

EP 2991289 A1 discloses an electronic device configured to communicate with a first electronic device and a second external device. The electronic device comprises a control unit configured to, when a message is received from the first electronic device, identify at least one of the second electronic device to which a message is sent in response to the message received from the first electronic device, and create and send a message to the second electronic device. The second electronic device may for example be a smart bulb or a speaker to notify the user that a status of the first electronic device, for instance a washing machine, has changed. The control unit may give priority to the plurality of the second electronic devices. The priority may be given on the basis of usage or malfunction of the second electronic devices. The electronic device may turn off the external devices on the basis of the priority.

### SUMMARY OF THE INVENTION

It is a first object of the invention to provide an electronic device, which can select a system which is believed to be able to provide the message in the most effective manner from a plurality of systems.

It is a second object of the invention to provide a method, which can select a system which is believed to be able to provide the message in the most effective manner from a plurality of systems.

In a first aspect of the invention, the electronic device comprises at least one processor configured to determine a message to be provided to a user, obtain a current mode of operation of a system capable of outputting audio and a current mode of operation of a system capable of outputting light, select a modality for providing said message to said user from a plurality of modalities and a system for providing said message to said user from a plurality of systems based on said obtained current modes of operation, said plurality of modalities including at least light and audio and said plurality of systems comprising said system capable of outputting audio and said system capable of outputting light, and cause said selected system to provide said message to said user in said selected modality. The message is preferably a notification message, such as an alert or reminder. The selected system may be the system capable of outputting audio or the system capable of outputting light, for example. The electronic device may be one of the plurality of systems, e.g. the system capable of outputting audio or the system capable of outputting light. A current mode of operation may be obtained by the electronic device from another device or from another software application running on the electronic device itself, for example.

The inventors have recognized that by making it possible to select a system for providing a message from a plurality of systems capable of providing the message, it is in certain situations possible to provide the message in a more effective manner than if only one system would be available for providing the message. The inventors have recognized that whether a modality in which a message is provided is effective depends on the current mode operation of the systems capable of providing the message. By selecting the modality and the system based on a current mode of operation of a system capable of outputting audio and a current mode of operation of a system capable of outputting light, a modality and system are selected which are believed to provide the message in the most effective manner. For example, if a lamp is currently outputting static light, it may be preferable to cause this lamp to provide the message using light, because the message will then be easy to notice and not disturb the user. If the lamp is currently outputting dynamic light, it may preferable to cause an audio system to provide the message using audio, especially if the audio system is currently not outputting any audio.

Said at least one processor may be configured to determine a ranking of a plurality of modes of operation, each of said plurality of modes of operation being associated with one of said plurality of modalities, select one of said plurality of systems whose current mode of operation ranks highest in said ranking, and select a modality associated with said highest ranked current mode of operation in said ranking. A ranking allows the at least one processor to make the selection in an easy-to-implement manner and helps make it possible to alter the ranking even after the electronic device has been manufactured. The at least one processor only needs to determine to which items in the ranking the current modes of operation correspond and select the highest-ranking item and the system and modality to which this highest-ranking item corresponds.

Said at least one processor may be configured to determine said ranking of said plurality of modes of operation at least partly based on preferences of said user. Although the ranking may be determined based on typical user preferences, e.g. based on results of user tests, instead of preferences of a specific user, users may have different preferences and determining the ranking specifically for the user for which the message is intended gives better results in certain situations.

Said at least one processor may be configured to analyze said user's response to said provided message and change said ranking in dependence on said response. By analyzing the response of the user, the preferences of the user may be derived without requiring the user to alter the ranking or indicate user preferences.

Said at least one processor may be configured to select said modality and said system based on said obtained current modes of operation and one or more properties of said message or of a further message, said at least one or more properties including at least one of an urgency, a privacy level and a sender of said message or said further message. The properties of the message or further message may be used to determine how noticeable the message should be and what kind of disturbance the message is permitted to cause. For example, an urgent message should be more noticeable and is permitted to cause more disturbance than a regular message. The message is preferably a notification and the further message may be an e-mail, chat message or a further notification, for example. As a first example, the electronic device may receive an e-mail and provide a notification of this e-mail, but not yet the e-mail itself, to the user. In this case, the e-mail is the further message and the notification is the message. As a second example, the electronic device may receive a notification from a cloud server and provide this notification to the user. In this case, the received and provided notification is the message and there is no further message.

Said at least one processor may be configured to detect an activity and/or an environment of said user and select said modality and said system based on said obtained current modes of operation and said detected activity and/or environment. The detected activity and/or the detected environment may be used to determine how noticeable the use of a certain modality is and/or how much disturbance the use of a certain modality causes. As a first example, if the user is eating alone, audio output may be acceptable, while light output may be preferred when the user is talking to someone. As a second example, audio output may be preferred over light output when a significant amount of daylight is detected.

Said current mode of operation of said system capable of outputting light may be one of: static light, dynamic light and lights switched off. Said current mode of operation of said system capable of outputting audio may be one of: playback of music, dialogue with said user, dialogue with a user other than said user and awaiting speech input. Changing from these modes of operation to another mode of operation typically cause a different level of disturbance to the user.

Said at least one processor may be configured to cause said selected system to provide said message to said user via a static or dynamic light effect. Light is generally a modality which causes less disturbance than audio, although this depends on the current mode of operation of the light device and possibly of the audio system.

Said at least one processor may be configured to, when said system capable of outputting audio is outputting audio, cause said system capable of outputting light to provide said message to said user via a static or dynamic light effect. Additionally or alternatively, said at least one processor may be configured to, when said system capable of outputting light is outputting light, cause said system capable of outputting audio to provide said message to said user via audio.

Said at least one processor may be configured to determine whether said user has received said provided message. Said at least one processor may be configured to select a further modality for providing said message to said user from said plurality of modalities and a further system for providing said message to said user from said plurality of systems based on said obtained current modes of operation if said user is not determined to have received said provided message within a predetermined period, and cause said selected further system to provide said message to said user in said selected further modality. If the user is determined not to have received the message, the message may be provided additionally or alternatively via a different system and a different modality. This increases the chances that the user receives, e.g. sees or hears, the message.

Said at least one processor may be configured to cause said selected system to provide said message to said user in said selected modality and said selected further system to provide said message to said user in said selected further modality during at least partly overlapping periods. Providing the message via multiple systems and modalities at the same time increases the chances that the user receives, e.g. sees or hears, the message.

Said at least one processor may be configured to select said light modality and said system capable of outputting light if said system capable of outputting light is outputting static light. If the system capable of outputting light is currently outputting static light, then this likely means that there is not too much daylight to make the light less noticeable and interrupting static light causes less disturbance than interrupting dynamic light. In this situation, light output via this system capable of outputting light is often preferable over audio output.

In a second aspect of the invention, the method comprises determining a message to be provided to a user, obtaining a current mode of operation of a system capable of outputting audio and a current mode of operation of a system capable of outputting light, selecting a modality for providing said message to said user from a plurality of modalities and a system for providing said message to said user from a plurality of systems based on said obtained current modes of operation, said plurality of modalities including at least light and audio and said plurality of systems comprising said system capable of outputting audio and said system capable of outputting light, and causing said selected system to provide said message to said user in said selected modality. The method may be implemented in hardware and/or software.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: determining a message to be provided to a user, obtaining a current mode of operation of a system capable of outputting audio and a current mode of operation of a system capable of outputting light, selecting a modality for providing said message to said user from a plurality of modalities and a system for providing said message to said user from a plurality of systems based on said obtained current modes of operation, said plurality of modalities including at least light and audio and said plurality of systems comprising said system capable of outputting audio and said system capable of outputting light, and causing said selected system to provide said message to said user in said selected modality.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the electronic device of the invention;

FIG. 2 is a block diagram of a second embodiment of the electronic device of the invention;

FIG. 3 is a flow diagram of a first embodiment of the method of the invention;

FIG. 4 is a flow diagram of a second embodiment of the method of the invention; and

FIG. 5 is a block diagram of an exemplary data processing system for performing the method of the invention.

Corresponding elements in the drawings are denoted by the same reference numeral.

### DETAILED DESCRIPTION OF THE EMBODIMENTS

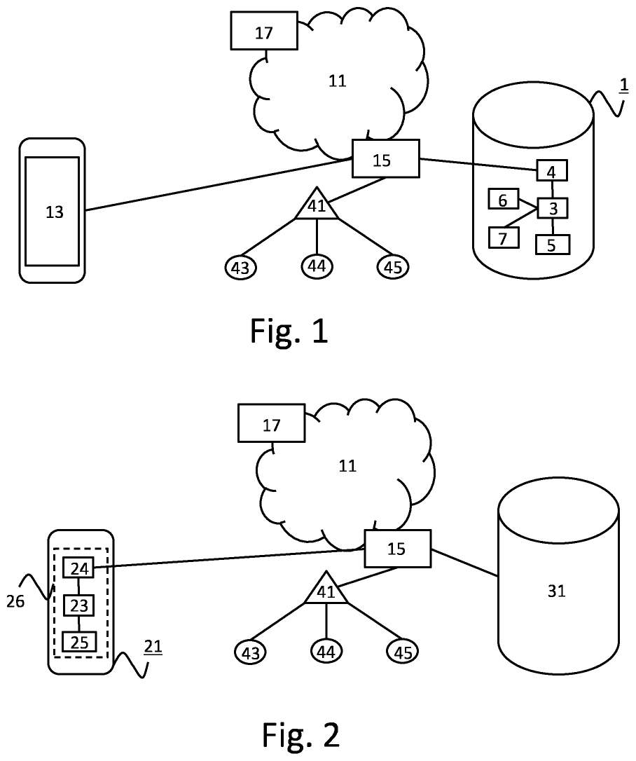

FIG. 1 shows a first embodiment of an electronic device of the invention, a smart speaker system 1. The smart speaker system 1 comprises a processor 3, a transceiver 4, storage means 5, a microphone 6 and a speaker 7. The smart speaker system 1 is capable of having a dialogue with a user by using the microphone 6 and the speaker 7. The smart speaker system 1 is connected to the Internet 11 via a wireless LAN (e.g. Wi-Fi/IEEE 802.11) access point 15. The smart speaker system 1 is further connected to lamps 43, 44 and 45 via bridge 41. The bridge 41 controls lamps 43 to 45, e.g. via ZigBee or a protocol based on ZigBee. The bridge 41 is connected to the same wireless LAN access point 15 as the smart speaker system 1, via a wire or wirelessly. A user of the smart speaker system 1 is able to control the lamps 43 to 45 via speech recognition (voice control). Mobile device 13, e.g. a mobile phone or a tablet, is also connected to the Internet 11 via wireless LAN access point 15. A user of the mobile device 13 is able to associate the lamps 43 to 45 with names, create named rooms, assign the lamps 43 to 45 to the named rooms, and control the lamps 43 to 45 via a touchscreen of the mobile device 13. The light and room names and the light to room associations are stored on the mobile device 13 and on a server on the Internet 11.

The processor 3 is configured to determine a message to be provided to a user, e.g. a message received from a server 17 on the Internet 11 or a message generated by the processor 3 itself, and obtain a current mode of operation of a system capable of outputting audio, smart speaker system 1 in the example of FIG. 1, and a current mode of operation of a system capable of outputting light, lamps 43 to 45 in the example of FIG. 1. The processor 3 is further configured to select a modality for providing the message to the user from a plurality of modalities and a system for providing the message to the user from a plurality of systems based on the obtained current modes of operation. The plurality of modalities includes at least light and audio. The plurality of systems comprises the system capable of outputting audio and the system capable of outputting light.

The processor 3 is further configured to cause the selected system to provide the message to the user in the selected modality. The message may be provided with static or dynamic light, for example. The color or pattern to be used for providing the message via light may be configurable by the user in case the message needs to be provided privately. The server 17 may be used by a digital assistant, e.g. Google Home or Amazon Echo, running on the smart speaker system 1 to store data. If a system cannot be remotely controlled, e.g. if a manual switch needs to be used to turn the system on, the system is considered not to be capable of providing the message. In the example of FIG. 1, the plurality of modalities only includes audio and light. In an alternative embodiment, the plurality of modalities also includes text. For example, the smart speaker system 1 may be able to display text via a small display.

In the embodiment of the smart speaker system 1 shown in FIG. 1, the smart speaker system 1 comprises one processor 3. In an alternative embodiment, the smart speaker system 1 comprises multiple processors. The processor 3 of the smart speaker system 1 may be a general-purpose processor, e.g. from ARM or Intel, or an application-specific processor. The processor 3 of the smart speaker system 1 may run a Linux operating system for example. In the embodiment shown in FIG. 1, a receiver and a transmitter have been combined into a transceiver 4. In an alternative embodiment, one or more separate receiver components and one or more separate transmitter components are used. In an alternative embodiment, multiple transceivers are used instead of a single transceiver. The transceiver 4 may use one or more wireless communication technologies to transmit and receive data, e.g. LTE, Wi-Fi, ZigBee and/or Bluetooth. In the embodiment shown in FIG. 1, the smart speaker system 1 further comprises storage means 5. The storage means 5 may comprise one or more memory units. The storage means 5 may comprise solid state memory, for example.

In the embodiment of FIG. 1, the processor 3 is configured to determine a ranking of a plurality of modes of operation. This ranking may be based on user preferences, e.g. specified by the user and/or re-ordered by the user. Each of the plurality of modes of operation is associated with one of the plurality of modalities. The processor 3 is further configured to select one of the plurality of systems (i.e. one of smart speaker system 1 and lamps 43 to 45) whose current mode of operation ranks highest in the ranking and select a modality associated with the highest ranked current mode of operation in the ranking. An example of such a ranking is shown in Table 1:

TABLE 1

| Rank | Type of system | Modality | Current mode of operation |
|---|---|---|---|
| 1 | Lamp | Light | Static light |
| 2 | Smart speaker | Audio | Listening mode (awaiting speech |
| | | | input) |
| 3 | Lamp | Light | Light switched off |
| 4 | Smart speaker | Audio | Dialogue with recipient of message |
| 5 | Lamp | Light | Dynamic light - dynamic scene |
| | | | (e.g. “fireplace”) |
| 6 | Smart speaker | Audio | Dialogue with other user |
| 7 | Lamp | Light | Dynamic light - enhance content on a |
| | | | display (e.g. TV) |
| 8 | Smart speaker | Audio | Playing back music |

As a first example, when the smart speaker system 1 is in listening mode (corresponding to rank #2), lamp 43 is outputting static light (corresponding to rank #1) and lamps 44 and 45 are switched off (corresponding to rank #3), lamp 43 and the modality light are selected. As a second example, when the smart speaker system 1 is in listening mode (corresponding to rank #2) and lamps 43 to 45 are outputting dynamic light to enhance content on a TV (corresponding to rank #7), smart speaker system 1 and the modality audio are selected. As a third example, when the smart speaker system 1 is having a dialogue with the user (corresponding to rank #4) and lamps 43 to 45 are switched off (corresponding to rank #3), one or more of the lamps 43 to 45 and the modality light are selected. One or two of the lamps 43 to 45 may be arbitrarily selected, for example.

As a fourth example, when the smart speaker system 1 is having a dialogue with the user (corresponding to rank #4) and lamps 43 to 45 are outputting a dynamic scene (e.g. resembling a fireplace; corresponding to rank #5), smart speaker system 1 and the modality audio are selected. In this case, the message may be provided after the current dialogue has finished or the current dialogue may be interrupted. In this or in another embodiment, the processor 3 is configured to analyze the user's response to the provided message and change the ranking in dependence on the response.

In this embodiment, the processor 3 is configured to select the modality and the system also based one or more properties of the message or of a further message and/or a detected activity and/or environment of the user. The at least one or more properties may include an urgency, a privacy level and/or a sender of the message or of the further message. The urgency, the privacy level and the sender may be extracted from a header of the message or of the further message, for example. Alternatively, a certain urgency and/or a certain privacy level may be associated with a sender of the message or of the further message, for example. Messages from a spouse may be marked as being urgent and private, for example. Alternatively, words of the further message may be analyzed in order to determine the urgency and/or privacy level of the message, for example. The further message may be an e-mail, chat message or notification, for example.

A more intrusive manner of providing the method may be chosen if the message is urgent, for example. For example, playback of music may be interrupted in case of an urgent message. Light output may be chosen instead of audio output if the message is private, for example. Only the user to which the message is provided may know what a certain color or a certain color pattern represents. The activity and/or environment of the user may be detected using a camera, a microphone, a light sensor and/or clock, for example. A camera may be used to determine whether the user is working, eating, reading or watching Television, for example.

In this embodiment and/or in another embodiment, the processor 3 is configured to determine whether the user has received the provided message, e.g. by using a camera, to select a further modality (e.g. light or audio) for providing the message to the user from the plurality of modalities and a further system for providing the message to the user from the plurality of systems (e.g. smart speaker system 1 or one of lamps 43 to 45) based on the obtained current modes of operation if the user is not determined to have received the provided message within a predetermined period, and cause the selected further system to provide the message to the user in the selected further modality. The processor 3 is configured to cause the selected system to provide the message to the user in the selected modality and the selected further system to provide the message to the user in the selected further modality during at least partly overlapping periods, e.g. if the message is urgent.

In a first example use case, the digital assistant running on the smart speaker system 1 provides a weather forecast to the user. If the person is having breakfast (i.e. the user is detected to be present at the kitchen table around 7:00) and not using the smart speaker system 1, a spoken weather forecast is given. Throughout the rest of the day, the user uses the smart speaker system 1 to playback music and the weather forecast will be visualized in the background through a color on one of the lamps 43 to 45.

In a second example use case, when a user walks into the living room after work, the smart speaker system 1 detects he is alone and ready to receive a spoken notification (e.g. based on camera input). Upon entrance, the digital assistant will tell the user that there is a message from his girlfriend. If the user would walk into the room while another user (e.g. a parent or child) is having a conversation with the digital assistant, the digital assistant would not tell the user that there is a message but would ask one of the lamps 43 to 45 to blink so the user can see there is a message. When the other user is finished with the digital assistant, the user could tap on the lamp, and the lamp or the bridge 41 could ask the digital assistant to read out the message.

In a third example use case, when a user sits in a noisy environment (for example because he is watching a movie), the smart speaker system 1 could detect the high noise levels using microphone 6 and decide not to give an auditory notification, but first a signaling of the message with one of the lamps 43 to 45, even though the lamps 43 to 45 are off and the smart speaker system 1 is not being used. As the user lowers the volume of the TV, the digital assistant starts reading out the notification.

In a fourth example use case, a user is watching his favorite TV show at 18:00 on a Saturday evening in his living room (this is detected by e.g. the TV show audio captured by a microphone, or by receiving information from the Television). The smart speaker system 1 is waiting for speech input. The lamps 43 to 45 are dynamically changing color and intensity in dependence on the image shown on the Television. At 20:00, the user is scheduled to meet his friends at a restaurant for a dinner party. At 18:20 the user receives a message. Different messages are handled in a different manner:
The message contains an update of the agenda of a meeting which takes place in 10 days from now. No immediate notification is required, because the message is not urgent (at the moment). The user can finish viewing his TV show and subsequently go to his dinner party. When he returns home from the dinner party (triggered by the geofencing service of the user's smartphone), one of the lamps 43 to 45 flashes blue once to indicate he has one low importance message he might be interested in. If he doesn't check his message in the next few days, the smart speaker system 1 might remind the user at an opportune/convenient moment that he has a relevant message waiting, e.g. by playing a voice message.
The message is from one of his friends telling him that tonight's dinner party has been pushed back to 21:00. This message is relevant in the short term, but the user still has time to finish his TV show undisturbed. The smart speaker system 1 may subtly indicate that he has a relevant, but not urgent message by slowly pulsing one of the lamps 43 to 45 that is in the user's angle of view once. Alternatively, the smart speaker system 1 may wait until there is a commercial break or the TV show is finished and then flash all of the lamps 43 to 45.
The message is from his friends that before the dinner party they will have a drink at the pub, where they would like to meet at 19:00. Since there is not enough time for the user to finish the TV show and still be in time to meet his friends, the smart speaker system 1 immediately informs him of an urgent message by repeatedly flashing all of the lamps 43 to 45 and by informing the user via audio output, e.g. using speech synthesis.

In the first embodiment of FIG. 1, it is the smart speaker system 1 which selects the modality and system and causes the selected system to provide the message. In the embodiment of FIG. 1, the smart speaker system 1 is only capable of providing the message via audio. In an alternative embodiment, the smart speaker system 1 has a display and/or a light and is capable of providing the message via the display and/or the light. If the selected system is the smart speaker system 1 itself, then the processor 3 controls the speaker 7 to provide the message. If the selected system is one of the lamps 43 to 45, then the smart speaker system 1 instructs the bridge 41 via the wireless LAN access point 15 to control the selected system in the specified manner. For example, if the message is a reminder and reminders in general or this category of reminders in particular has been associated with the color red, the speaker system 1 instructs the bridge 41 to have the selected lamp emit a red color.

FIG. 2 shows a second embodiment of an electronic device of the invention, a mobile device 21. The mobile device 21 comprises a processor 23, a transceiver 24, storage means 25 and a touchscreen 26. In this second embodiment, the invention is implemented in software running on a mobile device instead of in software running on a smart speaker system. In this second embodiment, the invention is used in a digital assistant running on the mobile device 21. In an alternative embodiment (not shown), the invention is implemented in software running on an Internet server. The invention may be implemented in embedded software, pre-installed software or downloadable software, for example.

The processor 23 is configured to determine a message to be provided to a user, e.g. a message received from a server 17 on the Internet 11 or a message generated by the processor 23 itself, and obtain a current mode of operation of a system capable of outputting audio (smart speaker system 31 in the example of FIG. 2) and a current mode of operation of a system capable of outputting light (lamps 43 to 45 in the example of FIG. 2). The processor 23 is further configured to select a modality for providing the message to the user from a plurality of modalities and a system for providing the message to the user from a plurality of systems based on the obtained current modes of operation. The plurality of modalities includes at least light and audio. The plurality of systems comprises the system capable of outputting audio and the system capable of outputting light. The processor 23 is also configured to cause the selected system to provide the message to the user in the selected modality.

In the embodiment of the mobile device 21 shown in FIG. 2, the mobile device 21 comprises one processor 23. In an alternative embodiment, the mobile device 21 comprises multiple processors. The processor 23 of the mobile device 21 may be a general-purpose processor, e.g. from ARM or Qualcomm, or an application-specific processor. The processor 23 of the mobile device 21 may run an iOS, Windows or Android operating system for example. The invention may be implemented using a computer program running on one or more processors.

In the embodiment shown in FIG. 2, a receiver and a transmitter have been combined into a transceiver 24. In an alternative embodiment, one or more separate receiver components and one or more separate transmitter components are used. In an alternative embodiment, multiple transceivers are used instead of a single transceiver. The transceiver 24 may use one or more wireless communication technologies to transmit and receive data, e.g. LTE, Wi-Fi, ZigBee and/or Bluetooth. The storage means 25 may store a lighting configuration and applications (also referred to as “apps”) and application data. The storage means 25 may comprise one or more memory units. The storage means 25 may comprise solid state memory, for example. The touchscreen 26 may comprise an LCD or OLED display panel, for example.

In the first embodiment of FIG. 2, it is the mobile device 21 which selects the modality and system and causes the selected system to provide the message. In the embodiment of FIG. 2, the smart speaker system 31 is only capable of providing the message via audio. In an alternative embodiment, the smart speaker system 31 has a display and/or a light and is capable of providing the message via the display and/or the light. If the selected system is the smart speaker system 31, then the processor 23 instructs the smart speaker system 31 to provide the message, e.g. directly via Bluetooth, directly via the wireless LAN access or via the Internet server 17. If the selected system is one of the lamps 43 to 45, then the mobile device 21 instructs the bridge 41, e.g. directly via the wireless LAN access point 15 or via the Internet server 17, to control the selected lamp in the specified manner.

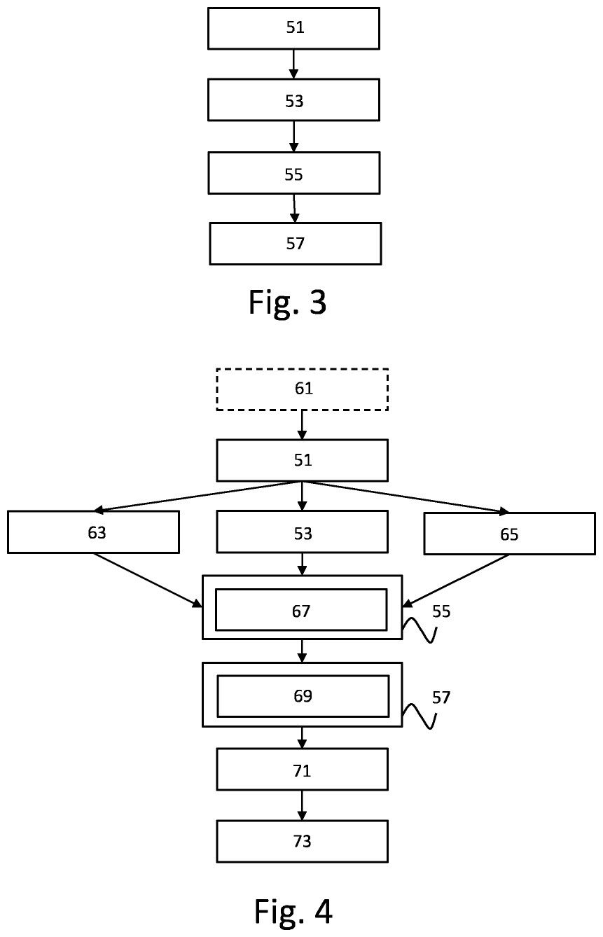

A first embodiment of the method of the invention is shown in FIG. 3. A step 51 comprises determining a message to be provided to a user. A step 53 comprises obtaining a current mode of operation of a system capable of outputting audio and a current mode of operation of a system capable of outputting light. A step 55 comprises selecting a modality for providing the message to the user from a plurality of modalities and a system for providing the message to the user from a plurality of systems based on the obtained current modes of operation. The plurality of modalities includes at least light and audio. The plurality of systems comprises the system capable of outputting audio and the system capable of outputting light. A step 57 comprises causing the selected system to provide the message to the user in the selected modality.

A second embodiment of the method of the invention is shown in FIG. 4. The second method comprises the steps of FIG. 3 plus additional steps. The message determined in step 51 may be a notification generated to provide a reminder or a notification generated to notify the user that a further message, e.g. an e-mail or alert, has been received in a step 61 which has been performed before step 51. The alert may be a news alert or weather alert, for example. The message or further message may be received via a cloud-based push notification service like IFTTT, Amazon Echo, Google Home, Apple Homekit, for example.

Step 63 comprises analyzing one or more properties of the message or the further message. A message handler is used to analyze the key properties of the message or further message, which typically include the urgency of the message (e.g. through an importance flag or a ‘read-before-date-time’), the identity of the sender and intended recipient of the message, and the type of content in the message. These key properties may be extracted from a header of the message or extracted from the message content. The urgency of the message can be represented with a classification system (e.g. low-medium-high), a numerical value (0-10), or a fixed time stamp (e.g. ‘expiration date’). The identity of the sender and recipient are typically represented as a unique ID, email account, name, or alike. The content type of the message can be represented by labels. These labels could for example capture the privacy level of the further message (‘private’, ‘public’). An urgency can be associated with certain senders (a list might be created of people that are more important like a partner and kids and less important like a neighbor and a motherin-law) and this urgency can be used to determine which system and modality to select for providing the message to the user.

Step 65 comprises analyzing the context of the user (i.e. of the recipient of the message). In this embodiment, step 65 comprises determining the following context aspects:

Presence and Identity of the User

As it is not useful to provide the message when the user for which the message is intended is not present, it is detected whether the user is in proximity of a system capable of providing the message. A person can be located with a presence or motion sensor, microphone, or camera, or with other indoor localization technology (e.g. RF signal analysis, visible light communication). Furthermore, the identity of the person in the room can be determined (e.g. using a mobile device ID, voice recognition or face recognition). If the determined identity does not match the identity of the intended recipient, the message will not be provided yet.

Social Context and Activities of the User

In addition, the social context and activities of the intended recipient are detected. The social context, e.g. whether the receiver is alone or with other people, can be detected with sensors such as a microphone and/or a camera. Activities of the receiver (e.g. activities like listening to music and gaming) can be determined with similar sensors or by devices used by the recipient of the message (e.g. a Television and/or a computer).

Physical Environment of the User

The physical environment of the intended recipient is also analyzed, e.g. by detecting the ambient light levels or sound levels in the room. The latter can be used to decide whether to use light or audio notifications and with what settings (e.g. light or sound level).

In an alternative embodiment, only one or two of the above aspects are determined and/or taken into account.

As part of step 55, step 67 comprises creating a notification plan based on the properties of the message or further message determined in step 63, the context determined in step 65 and a rule set. This rule set can be pre-defined based on designed application logic or contain a default rule set, but is typically (re-)defined by the user to personalize it to their preferences with respect to receiving notifications. Users may be able to define the rules, for example, via a settings menu in a smartphone app where they can see the default rule set and adapt it to their preferences.

A notification plan could consist of the following elements:
Condition(s) to release the notification
Condition(s) to determine the first notification mode (e.g. light, audio, or both)
Condition(s) to determine when to transition to subsequent notification mode(s) (e.g. light, audio, or both)
Condition(s) to stop the notification
Action(s) to render notification during the first notification mode
Action(s) to render notification during a subsequent notification mode

As part of step 57, step 69 comprises executing the notification plan. When the conditions as specified in the notification plan determined in step 67 are met, the corresponding actions as expressed in the notification plan are rendered on the relevant output devices. A series of control commands may be sent to these devices to render the notifications over time.

A step 71 comprises analyzing the user's response to the notification (i.e. to the message being provided). After release of the notification, the user's response can be monitored. This response may consist of explicit user input actions that indicate a negative response to the notification, such as an ‘overrule’ action (snooze, mute, stop, etc.) on a smartphone, via a voice command, etc. Alternative or additionally, this response may consist of implicit user input (observed behavior). For example, through analysis of facial expressions, utterances expressing annoyance or physiological measurements indicative of increased levels of stress or annoyance may be detected.

A step 73 comprises updating the rule set used in step 69. In this way, the system that uses this method can learn over time which particular notification schemes are preferred by the user and update the rule set accordingly.

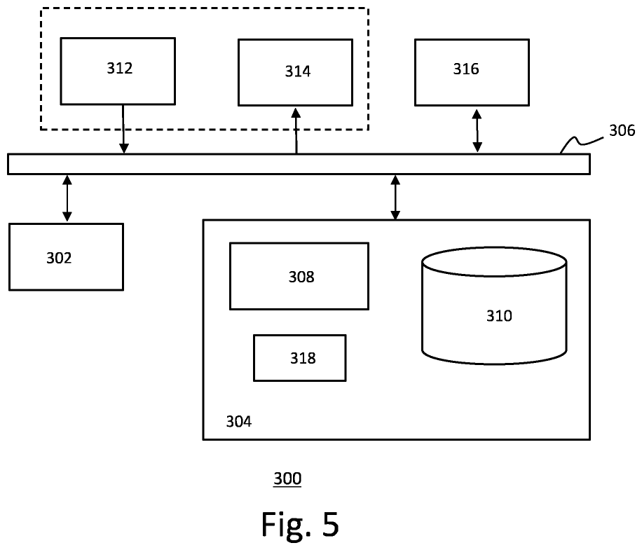

FIG. 5 depicts a block diagram illustrating an exemplary data processing system that may perform the method as described with reference to FIGS. 3 and 4.

As shown in FIG. 5, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 5 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 5, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 5) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. An electronic device comprising at least one processor configured to:
determine a message to be provided to a user,
obtain a current mode of operation of a system capable of outputting audio and a current mode of operation of a system capable of outputting light,
select a modality for providing said message to said user from a plurality of modalities and a system for providing said message to said user from a plurality of systems based on said obtained current modes of operation, said plurality of modalities including at least light and audio and said plurality of systems comprising said system capable of outputting audio and said system capable of outputting light, and
cause said selected system to provide said message to said user in said selected modality,
wherein said at least one processor is configured to determine a ranking of a plurality of modes of operation, each of said plurality of modes of operation being associated with one of said plurality of modalities, select one of said plurality of systems whose current mode of operation ranks highest in said ranking, and select said modality for providing said message to said user, wherein said selected modality is associated with said highest ranked current mode of operation in said ranking.

2. An electronic device as claimed in claim 1, wherein said at least one processor is configured to determine said ranking of said plurality of modes of operation at least partly based on preferences of said user.

3. An electronic device as claimed in claim 1, wherein said at least one processor is configured to analyze said user's response to said provided message and change said ranking in dependence on said response.

4. An electronic device as claimed in claim 1, wherein said at least one processor is configured to select said modality and said system based on said obtained current modes of operation and one or more properties of said message or of a further message, said at least one or more properties including at least one of an urgency, a privacy level and a sender of said message or said further message.

5. An electronic device as claimed in claim 1, wherein said at least one processor is configured to detect an activity and/or an environment of said user and select said modality and said system based on said obtained current modes of operation and said detected activity and/or environment.

6. An electronic device as claimed in claim 1, wherein said current mode of operation of said system capable of outputting light is one of: static light, dynamic light and lights switched off, and/or said current mode of operation of said system capable of outputting audio is one of: playback of music, dialogue with said user, dialogue with a user other than said user and awaiting speech input.

7. An electronic device as claimed in claim 1, wherein said at least one processor is configured to, when said system capable of outputting audio is outputting audio, cause said system capable of outputting light to provide said message to said user via a static or dynamic light effect.

8. An electronic device as claimed in claim 1, wherein said at least one processor is configured to, when said system capable of outputting light is outputting light, cause said system capable of outputting audio to provide said message to said user via audio.

9. An electronic device as claimed in claim 1, wherein said at least one processor is configured to determine whether said user has received said provided message.

10. An electronic device as claimed in claim 9, wherein said at least one processor is configured to:
select a further modality for providing said message to said user from said plurality of modalities and a further system for providing said message to said user from said plurality of systems based on said obtained current modes of operation if said user is not determined to have received said provided message within a predetermined period, and
cause said selected further system to provide said message to said user in said selected further modality.

11. An electronic device as claimed in claim 10, wherein said at least one processor is configured to:
cause said selected system to provide said message to said user in said selected modality and said selected further system to provide said message to said user in said selected further modality during at least partly overlapping periods.

12. An electronic device as claimed in claim 1, wherein said at least one processor is configured to select said light modality and said system capable of outputting light if said system capable of outputting light is outputting static light.

13. A method of causing a system to provide a message, comprising:
determining a message to be provided to a user;
obtaining a current mode of operation of a system capable of outputting audio and a current mode of operation of a system capable of outputting light;
selecting a modality for providing said message to said user from a plurality of modalities and a system for providing said message to said user from a plurality of systems based on said obtained current modes of operation, said plurality of modalities including at least light and audio and said plurality of systems comprising said system capable of outputting audio and said system capable of outputting light; and
causing said selected system to provide said message to said user in said selected modality,
wherein the step of selecting further comprises determining a ranking of a plurality of modes of operation, each of said plurality of modes of operation being associated with one of said plurality of modalities, select one of said plurality of systems whose current mode of operation ranks highest in said ranking, and selecting said modality for providing said message to said user, wherein said selected modality is associated with said highest ranked current mode of operation in said ranking.

14. A computer program or suite of computer programs comprising at least one software code portion or a computer program product storing at least one software code portion, the software code portion, when run on a computer system, being configured for enabling the method of claim 13 to be performed.
